(19) United States
(12) Patent Application Publication
(10) Pub. No.: US 2008/0034727 A1
(43) Pub. Date: Feb. 14, 2008

(54) Triple Cycle Power Plant

(75) Inventor: Tek Sutikno, Sugarland, TX (US)

Correspondence Address: Rutan & Tucker, LLP.;Hani Z. Sayed, 611 ANTON BLVD, SUITE 1400, COSTA MESA, CA, 92626, US

(73) Assignee: FLUOR TECHNOLOGIES CORPORATION, Aliso Viejo, CA (US)

(21) Appl. No.: 11/569,042

(22) PCT Filed: May 19, 2004
(86) PCT No.: PCT/US04/15833

§ 371 Date: Aug. 10, 2007

(51) Int. Cl. F02C 6/00

(52) U.S. Cl. 60/39.182

(57) ABSTRACT

Abstract: A refrigeration cycle is integrated into a combined cycle power plant to form a triple cycle power plant in which gas turbine generator inlet air is chilled and dehydrated to increase the mass flow of the inlet air, and in which duct firing in HRSG is increased in dependence of the increased mass flow. In further preferred integration aspects, the heat from the inlet chiller refrigerant is provided to the HRSG.

### FIELD OF THE INVENTION

Configurations and methods for combined cycle power plants.

### BACKGROUND OF THE INVENTION

In a typical Brayton cycle, the output from the combustion turbine generator (CTG) becomes significantly less at high ambient temperatures. This output reduction is a major financial drawback of the simple Brayton cycle or combined cycle power plant, as the power demand is high in summer. Inlet air cooling for open Brayton cycle configurations to increase net power output is well known in the art. However, in many cases the temperature of the inlet air must be kept above the dew point of the inlet air to avoid condensation, or even freezing out of the water contained in the inlet air. To avoid at least some of the problems associated with condensation during cooling, numerous improved configurations have been developed. For example, a freezing point depressant (which may also absorb water) may be sprayed onto the heat exchanger as described in U.S. Pat. No. 3,788,066 to Nebgen, or in U.S. Pat. No. 5,203,161 to Lehto.

Air inlet cooling systems and configurations were also adapted for use in combined cycle power plants, and an exemplary configuration is described in U.S. Pat. No. 6,058,695 to Ranasinghe et al. Here a distillation/condensation subsystem is coupled to a chiller system that cools the inlet air using the working fluid of the subsystem. While the inlet cooling of the '695 patent has various advantages, certain difficulties nevertheless remain. Among other things, Ranasinghe's system is typically limited to Kalina bottoming cycle configurations. Similarly, an inlet cooling configuration is described in U.S. Pat. No. 6,173,563 to Vakil et al. in which part of a multi-component working fluid is evaporated in an heat recovery steam generator (HRSG) to generate a vapor fraction, which is then separated from the non-evaporated working fluid and condensed. The so generated condensate is subcooled and used as a refrigerant to cool the inlet air. While thermal efficiency of the '563 process is typically improved, components, maintenance, and operation of such cooling systems are generally cost-prohibitive when compared to the overall capital gain.

Therefore, while numerous configurations and processes for power plants are known in the art, all or almost all of them, suffer from one or more disadvantage. Thus, there is still a need for improved power plants, and especially for improved combined cycle power plants.

### SUMMARY OF THE INVENTION

The present invention is directed to a power plant configuration and methods in which inlet air chilling is expanded and heat integrated with a combined cycle power plant. In especially preferred aspects, duct firing in the HRSG is increased as a function of increased mass flow of the inlet air due to the expanded inlet air chilling to thereby substantially improve power output. The rejected heat from the inlet air may further be provided to the HRSG to increase the thermal and energy efficiency associated with the use of inlet chilling in a CTG.

In one aspect of the inventive subject matter, a triple cycle power plant includes a refrigeration unit (preferably a vapor compression refrigeration unit) that is configured to cool inlet air for a gas turbine in an amount effective to increase mass flow of the inlet air, and to produce a heated refrigerant. An HRSG receives heat from the exhaust of the gas turbine, heat from a duct firing system, and optionally heat from the heated refrigerant, wherein the HRSG further produces steam for a steam turbine generator. A control circuit is operationally coupled to the plant and configured such that duct firing is increased in dependence of the increased mass flow of the inlet air.

Particularly contemplated plants may further comprise a moisture removal system (preferably comprising a triethylene glycol contactor) that removes water from the inlet air, which is typically chilled to a temperature of less than 32° F., and most typically between about −15° F. to about −5° F. Consequently, in at least some aspects of the inventive subject matter, the increase in mass flow of the inlet air is at least 10%, and more typically at least 15% relative to a mass flow without refrigeration. In further preferred configurations, the refrigeration unit has a first and second stage, and includes a moisture removal system that removes water from the inlet air at a position downstream of the first stage and upstream of the second stage.

Therefore, a method of operating a plant may include a step in which inlet air for a gas turbine is cooled to increase mass flow of the inlet air. In another step, duct firing in a heat recovery steam generator is increased as a function of the increased mass flow of the inlet air, wherein the HRSG receives heat from the exhaust of the gas turbine generator and produces steam for a steam turbine generator.

Various objects, features, aspects and advantages of the present invention will become more apparent from the following detailed description of preferred embodiments of the invention.

### BRIEF DESCRIPTION OF THE DRAWING

FIG. 1 is an exemplary schematic configuration of a triple cycle power plant.

### DETAILED DESCRIPTION

The inventor discovered that inlet air chilling can be expanded to a much cooler target chilled temperature and heat integrated with a combined cycle power plant in an economically attractive manner. In especially preferred aspects, duct firing in the HRSG is increased as a function of the increased mass flow of the inlet air due to the expanded inlet air chilling to thereby substantially improve power output. The rejected heat from the inlet air may further be provided to the HRSG to increase the thermal and energy efficiency associated with the use of inlet chilling in a CTG.

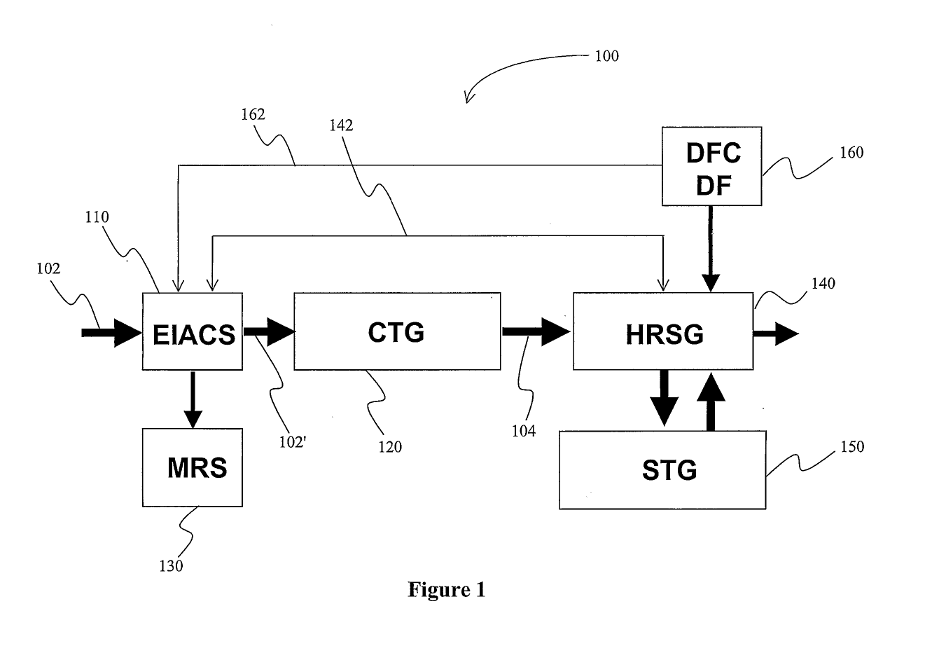

An exemplary triple cycle power plant configuration is depicted in FIG. 1 in which plant 100 has a combustion turbine generator 120 that receives chilled and dehydrated air 102′ from expanded inlet air chilling system 110. The moisture that is contained in the uncooled inlet air 102 is removed using moisture removal system 130, which is operationally coupled to the expanded inlet air chilling system 110. Combustion turbine exhaust 104 passes through heat recovery steam generator 140, which generates high-pressure steam for steam turbine generator(s) 150. A duct firing control system 160 controls the duct firing to the HRSG 140 in dependence of the increased air flow to the combustion turbine generator 120 via control circuit 162, heat rejected from inlet air 102 is further used as a heat source in HRSG 140 via integration loop 142.

With respect to contemplated plants, it should generally be appreciated that all plants are deemed suitable that have a combustion turbine with a heat recovery unit, and especially a heat recovery steam generator coupled to a steam turbine generator. Therefore, particularly contemplated plants include combined cycle power plants. While not limiting to the inventive subject matter, it should be appreciated that contemplated triple cycle configurations are especially advantageous where a plant is located in an environment subject to seasonal changes in temperature and/or humidity. However, contemplated plants also benefit from the configurations presented herein where seasonal changes in temperature and/or humidity are less significant. Furthermore, it is contemplated that integration of the third cycle (vapor compression refrigeration or other) may be done as a retrofit to an existing plant or as an integrated triple cycle plant.

Especially preferred inlet cooling systems provide inlet air chilling to a temperature that is at least 10° F., more typically at least 20° F., even more typically at least 40° F., and most typically at least 70° F. below ambient temperature to increase mass flow to the gas turbine generator. Therefore, contemplated inlet air temperatures after inlet air cooling will be less than 45° F., more typically less than 32° F., even more typically less than 20° F., and most typically less than 0° F. (e.g., between about −15° F. to about −5° F., but preferably above −25° F.). Depending on the particular refrigeration temperature, it is contemplated that the increase in mass flow of the inlet air is between about 5% and 10%, more preferably between about 10% and 20%, even more preferably at least 15%, and most preferably at least 20% (calculated relative to a mass flow without inlet air refrigeration). There are numerous configurations and methods for air refrigeration known in the art, and all of them are deemed suitable for use herein. However, in particularly preferred aspects, inlet air refrigeration is performed using vapor compression refrigeration with a single refrigerant or a refrigerant mixture.

Especially preferred vapor compression refrigeration systems include those in which a first chiller cools inlet air to a first reduced temperature (which is then preferably dehydrated in a moisture removal system), and in which a second chiller further cools the dehydrated and pre-cooled inlet air to a target inlet temperature. Therefore, in at least some of contemplated aspects, a moisture removal system is located downstream of a first chiller and upstream of a second chiller. Alternatively, alternative cooling systems may be employed having a single cooling stage or more than two chillers. For example, where the combined cycle power plant is operationally coupled (or proximal) to a plant in which significant refrigeration capacity is available (e.g., from LNG (liquefied natural gas) liquefaction or expansion of high pressure natural gas), the inlet cooling system may include multiple chillers.

Where desired, it is contemplated that the heat rejected from the inlet air and/or from the compressed refrigerant may be transferred to various sinks, and particularly suitable heat sinks include various low-heat heat sinks, boiler feed water from vacuum condensate pumps, etc. Alternatively, the heat may be disposed of in a cooling tower.

Moisture removal systems may be placed at any position upstream of the turbine inlet, however, it is generally preferred that the moisture removal system is positioned between the first and second chiller stage. There are numerous moisture removal systems known in the art, and all of those are deemed suitable for use herein. For example, dehydration of the inlet air may be performed using adsorption (e.g., using molecular sieves), spraying of a hygroscopic solvent onto a chiller surface, or using a solvent based absorption process. However, it is especially preferred that the moisture removal system comprises a triethylene glycol-based (TEG) system. Such TEG systems are well known in the art and achieve water removal at relatively high efficiency using relatively low amounts of energy.

Depending on the uncooled inlet air moisture content and temperature, and the desired cooled inlet air temperature, the configuration and capacity of contemplated dehydration units may vary considerably. However, it is generally preferred that the cooled inlet air has a temperature and moisture content such that the cooled inlet air is at a temperature above the dew point, and most typically between about 5-10° F. above the dew point.

With respect to contemplated combustion turbine generators and steam turbine generators, it should be recognized that all known combustion turbine generators and steam turbine generators are suitable for use herein. However, especially preferred generators include those employed in combined cycle power plants that generate at least 10 MW, and more typically at least 100 MW output. Similarly, contemplated HRSG include all known HRSGs so long as such steam generators allow for duct firing. While in some of contemplated aspects conventional duct firing may be appropriate, modifications to the HRSG may be made to increase temperature and/or pressure ratings due to the increase in duct firing. However, without the expanded inlet air chilling system resulting in higher exhaust mass flows from the combustion turbine, the increase in the HRSG temperature rating required for high levels of duct firing would lead to prohibitive HRSG capital costs primarily due to the design temperature limits of cost competitive, conventionally used tube materials.

It should generally be appreciated that the increase in duct firing may be controlled in numerous manners, and that all known manners of duct firing control are considered appropriate herein. For example, where the increase in mass flow results in a decrease in the HRSG temperature, the increase in duct firing may be controlled via automatic temperature control. On the other hand, and especially where the plant is located in an environment with relatively small changes in inlet temperature and/or humidity, it is also contemplated that the increase in duct firing may be predetermined and manually set by an operator.

Therefore, the inventors generally contemplate a triple cycle power plant comprising a refrigeration unit that is configured to cool an inlet air for a gas turbine generator in an amount effective to increase mass flow of the inlet air and to produce a heated refrigerant. A heat recovery steam generator is coupled to the gas turbine and receives heat from the exhaust of the gas turbine generator, heat from a duct firing system, and optionally heat from the heated refrigerant, wherein the heat recovery steam generator produces steam for a steam turbine generator. A control circuit in such plants is further included and configured such that duct firing is a function of the increased mass flow of the inlet air (typically: duct firing is increased with increased inlet air cooling).

Consequently, a method of operating a triple cycle plant will therefore include one step in which inlet air for a gas turbine generator is cooled to thereby increase the power output from the combustion turbine and the mass flow of the inlet air. In another step, duct firing in a heat recovery steam generator is increased as a function of the increased mass flow of the inlet air (typically: duct firing is increased with increased inlet air cooling), and in yet another step, steam is produced in a heat recovery steam generator that receives heat from an exhaust of the gas turbine generator and also part of heat rejected from the chilled inlet air.

### EXAMPLE

The following example for a triple cycle configuration was based on a combined cycle (CC) power plant employing two GE 7FA combustion turbine generators (CTG's) and one GE D11-type steam turbine generator (STG) with HRSG duct firing. An expanded inlet air chilling system (EIACS) was configured to chill the combustion turbine inlet air to −10° F. A TEG-based moisture removal system (MRS) was added to avoid icing at the compressor inlet. Heat integration was further based on both, high CTG exhaust mass flow (and with that increased duct firing) and use of rejected heat from the EIACS.

The performance of the EIACS and the MRS were evaluated with HYSYS models developed to simulate the selected configurations. Other published design data were also used where applicable. GT-PRO/MASTER was used to analyze the benefits of heat integration schemes. All evaluations are based on preliminary specifications of design parameters, and it should be appreciated that the performance and/or economics may vary with varying process parameters.

Expanded Inlet Air Chilling System

In the present example, the expanded inlet air chilling system had two air chillers, Chiller I and Chiller II. Chiller I was essentially the same as a conventional GE 7FA CTG inlet chiller, which was configured to cool the inlet ambient air typically to 45° F. The air conditions were specified as: 90° F. dry bulb, 76° F. wet bulb, and 0 feet elevation. The 45° F. inlet air generated by Chiller I then flowed to one of the TEG contactors of MRS where the moisture content was reduced (infra). Chiller II then cooled the dehydrated air to −10° F. before entering the combustion turbine compressor. It should be appreciated that both Chillers I and II can be integrated with the combined cycle plant to improve efficiency and to lower capital costs, especially when the required compressors are commercially available as off-the-shelf designs.

Ambient conditions were set to 90° F. dry bulb and 76° F. wet bulb at zero elevation. Using these parameters, GT Master calculated 3,260,000 lbm/hr inlet air flow and 149 MW net output from a GE 7FA CTG without an inlet air chiller. In contrast, with EAICS chilling the inlet air to −10° F., both the inlet air flow and output increase to 3,920,000 lbm/hr and 190 MW respectively. Thus, the EIACS provides about 82 MW additional CTG output from a 2×1 7FA combined cycle plant.

Based on various HYSYS model calculations, the EIACS options consumed from about 22 MW to 32 MW (depending on the efficiency of the selected EIACS), thus providing a net additional output of 50 MW to 60 MW from the two 7FA CTGs. Moreover, the EIACS also generates much higher exhaust mass flows enabling higher STG output from higher allowed levels of HRSG duct firing as discussed below in the section entitled “Duct Firing”.

Moisture Removal System

The moisture removal system (MRS) included a triethylene glycol (TEG) contactor and a TEG Regenerator Unit (TRU). The TEG contactor was configured as a bed of structure packing in which the CTG inlet air flows upward in countercurrent with TEG flowing downward through the packing. The TRU regenerates the water-rich TEG from the contactor by water vaporization and continuously supplies the regenerated TEG back to the contactor. Stripping gas may be needed for the conventional design of the TRU if higher than 98.5 weight % of regenerated TEG is required. However, a number of designs are also known in the art to achieve 99.99 weight % TEG without stripping gas. In most calculations, the MRS was set to reduce the moisture content of the 45° F. chilled air from Chiller I to a dew point of −25° F.(0.0002 lbm of water/Ibm of dry air). As the target chilled air temperature for Chiller II is −10° F., the dew point of −25° F. allows −15° F. margin to account for potential air temperature drops due to higher velocities at the compressor intake nozzle.

A HYSYS model was developed to simulate the performance of the MRS required to reduce the inlet air from a moisture content of 0.0063 lb water/lb of dry air (45° F. Saturated) to 0.00019 lb water/lb of dry air (−25° F. dew point). With a concentration of 99.9 weight percent for the regenerated TEG supplied by the TEG regeneration unit, HYSYS calculations indicated that about 1070 gpm of regenerated TEG were required to reduce the 3,920,000 lbm hr inlet at 45° F. saturated to a dew point of −25° F. The HYSYS models also indicated that, at 1070 gpm of regenerated TEG, a total of six theoretical “mass-transfer” stages were required in the TEG contactor.

It should be recognized that although TEG has been widely used for dew point control of natural gas, TEG has not been commercially used for moisture removal of inlet air to 7FA gas turbines. Nevertheless, all of the published data for natural gas seem to suggest that 99.9 wt % TEG is adequate to reach an air dew point of −25° F. (higher concentration of regenerated TEG will reduce the required rate of TEG circulation, the number of theoretical stages, and the required capacity and capital cost of the required regeneration units). Furthermore, it was calculated that the total air side pressure drop of the TEG contactor will decrease output by about 0.36 MW for every inch water of pressure drop in CTG inlet at −10° F. For example, using a 15 ft contactor bed depth located in the extended air duct scheme, the total pressure drop across the extended air inlet duct, the TEG contactor, and second chiller coil is about 4.5 inches of water. This pressure drop was calculated using a correlation provided by the packing vendor and loss coefficients published by ASHRAE. As the total inlet pressure drop for GE 7FA with inlet chilling to 45° F. is typically 4 inches of water, the new total pressure drop including all of the triple cycle features is about 8.5 inches of water.

Duct Firing

Relative to ambient condition of 90° F., the −10° F. chilled air temperature increased the CTG exhaust mass flow by about 20%. This higher mass flow allowed a significantly higher level of HRSG duct firing without exceeding the temperature limits of commonly used HRSG tube materials. To explore the potential benefits of the EIACS on the STG output, GT-Master runs using a model with typical/conventional 2002 HRSGs designed for a duct-fired CC plant employing two GE 7FA combustion turbines and 300-330 MW D11 STG were performed. Among other things, the results showed that chilling the CTG inlet air to −10° F. from ambient conditions of 90° F. dry bulb/76° F. wet bulb allows duct firing to reach the ultimate capacity of 405 MW for the D11 STG.

The inlet orifice areas of the STG model have been adjusted primarily to maintain HP inlet pressure of about 1927 psia. The calculated duct firing temperature is 1784° F., which is within maximum firing limit of typical/conventional 2002 HRSGs which have a normal firing temperature of 1763° F. (e.g., DENA HRSG). Where needed, water wall features for high duct firing temperatures may be employed. Under typical operating conditions, duct firing to 405 MW STG output was calculated not to exceed HRSG duct firing limits.

Recovery of Heat from Chillers

Heat integration in the exemplary calculations also included use of the condensate and/or feed water from the vacuum condensate pumps to condense the refrigerant in the chiller condensers. Thus, it should be recognized that the heat rejected from the EIACS will be recovered in the condensate before flowing back to the HRSGs, which is thought to reduce or even eliminate the need for a chiller cooling tower (and the associated chiller cooling water pumps). Therefore, recovery of heat rejected from the chillers improves overall plant efficiency and reduces the net plant heat rate. It should be recognized that the particular extent of heat rate reduction will depend on the particular choice of refrigerant for the chillers and/or the associated operational parameters (e.g., cooling water supply temperature and the terminal temperature difference (TTD) of the condenser) of equipment in the bottoming cycle.

Primarily because of the increased HRSG duct firing level, the net plant heat rate for the 405 MW STG output reaches about 7324 BTU/kWh. This rate may be further lowered by recovering heat rejected from the EIACS to the bottoming cycle. To transfer the heat from the chiller condensers to the condensate from the steam surface condenser, the refrigerant condensing temperature range must be adequately higher than the temperature range of the condensate being heated. Refrigerant condensing temperatures may be increased without a reduced efficiency primarily by selecting certain types of refrigerant mixtures. Alternatively, or additionally, refrigerant condensing temperatures can also be increased by raising the supply temperature of the cooling medium, which will increase the power consumption of chiller and reduce the coefficient of performance (COP). In still further contemplated aspects, the condensate temperature or the STG exhaust steam condensing temperature can be lowered to some extent allowing recovery of heat rejected from the chillers, which will reduce the heat rate and increase the STG output.

At ambient conditions of 90° F. dry bulb and 76° F. wet bulb, the EIACS with −10° F. target chilled air temperature was calculated to generate about 400 MMBTU/hr of relatively low temperature heat, typically rejected to the chiller cooling tower. For the bottoming cycle configurations of a typical/conventional, 2002 combined cycle (CC) plant with 2 GE 7FA CTGs operating at 90° F. dry bulb and 76° F. wet bulb, duct firing the HRSGs to generate 405 MW STG yielded a condensate temperature of about 135° F., which is about the typical maximum exhaust temperature limit for D11 STG.

Relative to a typical CC plant design with HRSG duct firing in 2002, duct firing to 405 MW STG corresponded to a 36% increase on the bottoming cycle capacity (roughly about 138% additional STG output relative to the similar plant without HRSG duct firing). The net plant heat rate of 7324 BTU/kWh can be further lowered by expanding the bottoming cycle capacity to a net plant heat rate of 7224 BTU/kWh operating at the same design ambient conditions of 90° F. dry bulb and 76° F. wet bulb. Thus, based on our calculations, expanded bottoming cycle reduced the heat rate by about 100 BTU/kWh. Heat integration still further reduced the heat rate to 7146 BTU/kwh. A net heat reduction of about 75 BTU/kWh can be attained when the 104° F. condensate temperature is increased to 153° F. by recovering the some of the rejected heat from the EAICS using refrigerant mixtures such as 20% R-170, 20% R-290, and 60% R-600 in Chiller I and 1% R-170, 70% R-290, and 29% R-600 in Chiller II.

Thus, specific embodiments and applications of triple cycle power plants have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A triple cycle power plant comprising:
a refrigeration unit configured to cool an inlet air for a gas turbine generator in an amount effective to increase mass flow of the inlet air and to produce a heated refrigerant;
a heat recovery steam generator that receives heat from exhaust of the gas turbine generator, heat from a duct firing system, and optionally heat from the heated refrigerant, wherein the heat recovery steam generator produces steam for a steam turbine generator; and
a control circuit that is configured such that duct firing is a function of the increased mass flow of the inlet air.

2. The triple cycle power plant of claim 1 wherein the refrigeration unit comprises a vapor compression refrigeration unit.

3. The triple cycle power plant of claim 1 further comprising a moisture removal system that removes water from the inlet air.

4. The triple cycle power plant of claim 3 wherein refrigeration unit comprises a vapor compression refrigeration unit and wherein the moisture removal system comprises a triethylene glycol contractor.

5. The triple cycle power plant of claim 1 wherein the cooled inlet air has a temperature of less than 32° F.

6. The triple cycle power plant of claim 1 wherein the cooled inlet air has a temperature of between about −15° F. to about −5° F.

7. The triple cycle power plant of claim 1 wherein the refrigeration unit is configured to increase mass flow of the inlet air at least 10% relative to a mass flow without refrigeration.

8. The triple cycle power plant of claim 1 wherein the refrigeration unit is configured to increase mass flow of the inlet air at least 15% relative to a mass flow without refrigeration.

9. The triple cycle power plant of claim 1 wherein the refrigeration unit comprises a first stage and a second stage, and wherein a moisture removal system that removes water from the inlet air is downstream of the first stage and upstream of the second stage.

10. The triple cycle power plant of claim 9 wherein the refrigeration unit is configured to increase mass flow of the inlet air at least 15% relative to a mass flow without refrigeration.

11. A method of operating a plant comprising the steps of:
cooling inlet air for a gas turbine generator to increase mass flow of the inlet air;
increasing duct firing in a heat recovery steam generator, wherein the increase in duct firing is a function of the increased mass flow of the inlet air; and
producing steam in a heat recovery steam generator that receives heat from an exhaust of the gas turbine generator.

12. The method of claim 11 wherein cooling is performed using a refrigerant to thereby produce a heated refrigerant.

13. The method of claim 12 wherein the heat recovery steam generator further receives heat from the heated refrigerant.

14. The method of claim 11 wherein the inlet air is cooled below a dew point and wherein a moisture removal system removes water from the cooled inlet air.

15. The method of claim 14 wherein cooling is performed using a vapor compression refrigeration unit, and wherein the moisture removal system comprises a triethylene glycol contactor.

16. The method of claim 11 wherein the inlet air is cooled to a temperature of less than 32° F.

17. The method of claim 11 wherein the inlet air is cooled to a temperature of between about −15° F. to about −5° F.

18. The method of claim 11 wherein the inlet air is cooled to increase mass flow of the inlet air at least 10% relative to a mass flow without refrigeration.

19. The method of claim 11 wherein the inlet air is cooled to increase mass flow of the inlet air at least 15% relative to a rnass flow without refrigeration.

20. The method of claim 19 wherein the inlet air is cooled in a refrigeration unit that has a first stage and a second stage, and wherein a moisture removal system that removes water from the inlet air is downstream of the first stage and upstream of the second stage.
